(19) United States
(12) Patent Application Publication
(10) Pub. No.: US 2014/0297762 A1
(43) Pub. Date: Oct. 2, 2014

(54) METHOD AND SYSTEM FOR TIMEZONE AWARE APPLICATION PROGRAMMING INTERFACE

(71) Applicant: Manu Chikkanna, Bangalore (IN)

(72) Inventor: Manu Chikkanna, Bangalore (IN)

(73) Assignee: INTUIT INC., Mountain View, CA (US)

(21) Appl. No.: 13/866,658

(22) Filed: Apr. 19, 2013

(30) Foreign Application Priority Data
Apr. 2, 2013 (IN) 369/KOL/2013

(51) Int. Cl. H04L 12/58

(52) U.S. Cl. CPC H04L 51/20
USPC 709/206

(57) ABSTRACT

A method for sending a message using a platform comprises: receiving, by the platform, a request comprising at least one target, a time, and a content, the time is identifying when the message will be delivered. The method further comprises identifying a time zone of the target, calculating, by the processor, when the time will occur in the time zone of the target to determine a delay, storing the request and the delay, determining that the delay has expired, generating the message for the at least one target wherein a payload in the message is based on the content, and sending, in response to determining, the message to the target.

### CROSS-REFERENCE TO RELATED APPLICATIONS

This application claims priority, under 35 U.S.C. §119(a), to Indian Patent Application No. 369/KOL/2013, filed on Apr. 2, 2013, and entitled: “METHOD AND SYSTEM FOR TIMEZONE AWARE APPLICATION PROGRAMMING INTERFACE.”

### BACKGROUND

As the use of e-mail, text messaging, and applications grows, users are becoming overwhelmed by the volume of notifications and announcements that are sent. As users become overwhelmed, they either disable the notifications altogether, which may severely limit the functionality of some applications, or users may reduce the visibility of the notifications. This is disadvantageous for the publisher/creator of the application, as it limits user engagement and results in a more rapid loss of users.

### SUMMARY

In general, in one aspect, the invention relates to a method for sending a message using a platform. The method comprises: receiving, by the platform, a request comprising at least one target, a time, and a content, wherein the time is when the message will be delivered; identifying a time zone of the target; calculating, by the processor, when the time will occur in the time zone of the target to determine a delay; storing the request and the delay; determining that the delay has expired; generating the message for the at least one target wherein a payload in the message is based on the content; and sending, in response to determining, the message to the target.

In general, in one aspect, the invention relates to a non-transitory computer-readable medium (CRM) storing a plurality of instructions for sending a message using a platform, the plurality of instructions comprising functionality to: receive, by the platform, a request comprising at least one target, a time, and a content, wherein the time is when the message will be delivered; identify a time zone of the target; calculate, by the processor, when the time will occur in the time zone of the target to determine a delay; store the request and the delay; determine that the delay has expired; generate the message for the at least one target wherein a payload in the message is based on the content; and send, in response to determining, the message to the target.

In general, in one aspect, the invention relates to a system for sending a message using a platform. The system comprising: a processor; and a memory comprising instructions which, when executed by the processor, comprise functionality to: receive, by the platform, a request comprising at least one target, a time, and a content, wherein the time is when the message will be delivered; identify a time zone of the target; calculate, by the processor, when the time will occur in the time zone of the target to determine a delay; store the request and the delay; determine that the delay has expired; generate the message for the at least one target wherein a payload in the message is based on the content; and send, in response to determining, the message to the target.

Other aspects of the invention will be apparent from the following description and the appended claims.

### BRIEF DESCRIPTION OF DRAWINGS

FIG. 1 shows a system diagram in accordance with one or more embodiments of the invention.

FIG. 2 shows a flowchart of a method in accordance with one or more embodiments of the invention.

FIGS. 3A-3C show an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for sending a message using a platform. More specifically, in one or more embodiments of the invention, the message includes a target, time, and content. The time typically indicates when the message will be sent or delivered. After the message is received on the platform, the time zone of the target(s) is identified, and a delay is determined by calculating when the time will occur in the identified time zone(s). The message and the delay are subsequently stored, and when the delay expires, the message is sent to the target(s).

Today's mobile devices, such as smart phones, allow users to browse the Internet from any location to obtain information on demand. Typically, as long as a user is in a geographic area with a telecommunication network and subscribes to a data plan, the user is provided with access to the Internet for web browsing to obtain information such as phone numbers for service provides maps to a particular destination location, and information relevant to the user's current or future activities. However, there are often instances in which a user wishes to access only limited information for a quick answer to a question (e.g., what are the next available show times for a particular movie?). In this scenario, browsing the website for the movie theater or a service provider website that provides movie show times may be cumbersome on the mobile device. Specifically, loading all the graphics and advertisements associated with websites on a mobile device can take additional time. In other words, the entire website may provide too much data to navigate through when a user desires only a specific piece of information. In addition, for mobile device users who do not subscribe to a data plan for browsing the Internet, are in an area without telecommunication network that support the aforementioned type of Internet access via a phone, or do not have browsing capability on their mobile device, accessing such information is typically not possible.

As an alternative, information content similar to what is available via the Internet may be provided by a text messaging service (TMS) based platform. For example, the user may request desired information by sending a registered keyword via a TMS message to the TMS based platform. The registered keyword identifies such user requested information and is registered with the TMS based platform by an information publisher. As additional information is published in the TMS based platform, the registered keyword collection grows in size and the user needs an effective discovery mechanism to find new keyword that identifies published information of interest to the user.

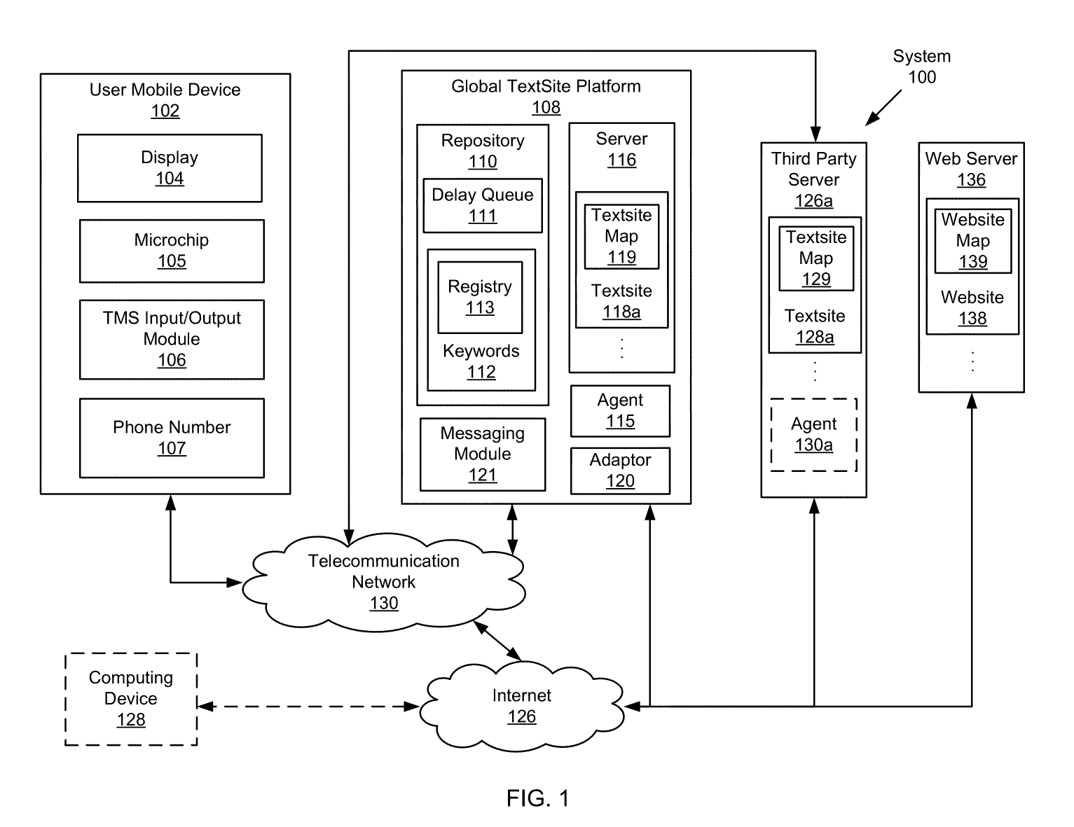

FIG. 1 shows a block diagram of a system (100) for accessing content from a textsite in accordance with one or more embodiments of the invention. Specifically, FIG. 1 shows the global textsite platform (GTP) (108), a user mobile device (102), and a computing device (128) coupled via the telecommunication network (130) and/or the Internet (126). In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

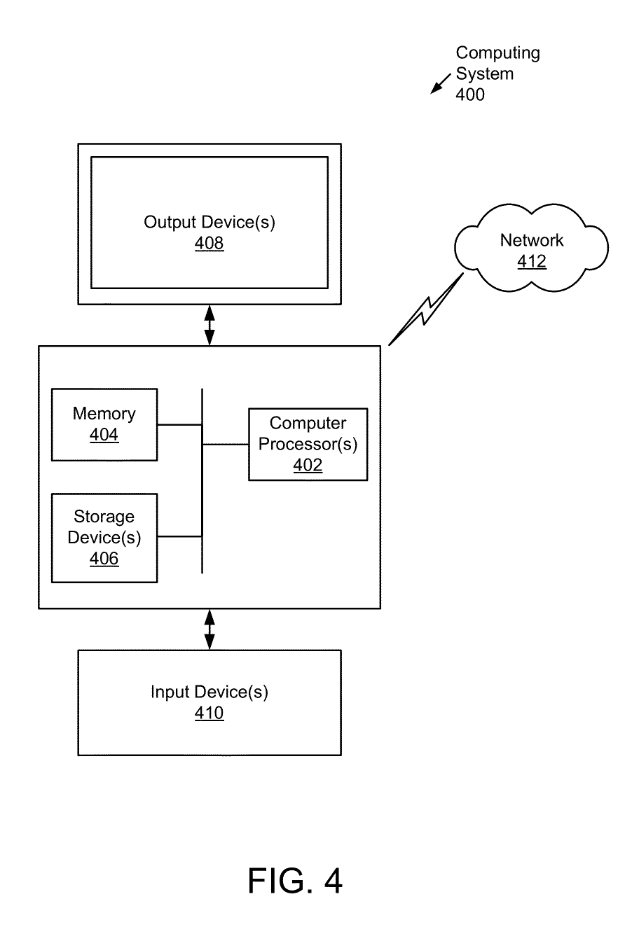

In one or more embodiments of the invention, the global textsite platform (108) executes on one or more computing device(s) (e.g., a server, a computer system as shown in FIG. 4 and described below, etc.) and may be hosted by an entity, such as a corporation. In one or more embodiments of the invention, the global textsite platform (108) is associated with a platform syntax that is specific to the global textsite platform (108) and facilitates communication via a TMS. In one or more embodiments of the invention, the global textsite platform (108) may be associated with different unique phone numbers or codes corresponding to each different geographic location. Alternatively, a single, unique global number/code may be associated with the global textsite platform (108). In one or more embodiments of the invention, the global textsite platform (108) includes a repository (110) for storing keywords (112), a server (116) configured to host a plurality of textsites (e.g., textsite (118a)), an agent (115), an adaptor (120), and a messaging module (121). Those skilled in the art will appreciate that the server (116) may be any computing device with a large storage capacity.

The repository (110) may be any datastore (flat file, hierarchical file, relational database, enterprise-wide database, etc.) capable of storing data, regardless where or in what form the data originates. In one or more embodiments of the invention, repository (110) includes delay queue (111), which is a queue organized by the length of the delay associated with a given message and target. However, delay queue (111) may be any suitable type of data structure, such as lists, arrays, matrixes, etc., and should not be limited to a queue. Delay queue (111) is communicatively connected to messaging module (121) and stores message content, target information, time zone information, delays, and/or any other data used by messaging module (121) for sending messages. In one or more embodiments of the invention, the messages stored in delay queue (111) are generated in advance of storage in delay queue (111). That is, in other words, the messages stored in delay queue (111) may be sent without further processing. Alternatively, the messages stored in delay queue (111) may require further processing, and may be generated just-in-time, thereby ensuring that the content of the message is current, despite there being a delay before the message is sent.

In one or more embodiments of the invention, keywords (112) may be reserved or pre-designated keywords maintained by the platform as part of the platform syntax, and publisher keywords that are registered by publishers for each textsite authored by a publisher. In one or more embodiments of the invention, pre-designated keywords and publisher registered keywords are unique. That is, no two keywords from the group of keywords that are pre-designated as platform syntax or the group of keywords provided by a publisher are allowed to be identical. In fact, in one or more embodiments of the invention, the keywords (112) are closely controlled by the global textsite platform (108) in an effort to eliminate duplicates. Navigating keywords, which a publisher defines for a textsite that is associated with a unique registered keyword, are also used. Navigating keywords are not required to be unique. For example, two distinct publishers with distinct registered keywords representing a first and a second textsite may use the same navigating keyword for different text pages associated with the first and second textsites.

In one or more embodiments, a portion of the keywords (112) is organized as a registry (113) storing a number of registered unique keywords each used as a site identifier and associated with metadata describing a mechanism for accessing corresponding site content, such as content stored in the textsite (118a), etc. In one or more embodiments, the registered unique keywords (i.e., used as site identifiers) are registered by textsite content publishers with relevant information processed into associated metadata. In one or more embodiments, the textsite (118a) may be hosted by the global textsite platform (108) on behalf of a first publisher or may be an in-house textsite maintained by the global textsite platform (108). In such embodiments, the metadata associated with the registered unique keyword (i.e., used as site identifiers) includes an internal link to the textsite (118a) within the global textsite platform (108).

In one or more embodiments, the textsite (128a) is published by a second publisher that has registered with the global textsite platform (108) but is hosted on a separate third party server (126a). In such embodiments, the metadata associated with the registered unique keyword (i.e., used as site identifier) includes an access path for the global textsite platform (108) to access the third party server (126a) via the telecommunication network (130) and/or the Internet (126). In one or more embodiments, the third party server (126a) may include agent (130a) configured with similar functionalities as those of the agent (115). For example, the agent (130a) may be provided to an operator of the third party server (126a) by an operator of the GTP (108) under a pre-determined business agreement (e.g., a licensing agreement).

In one or more embodiments, contents of the website (138) are converted by the global textsite platform (108) to be accessible to a user via TMS. In such embodiments, the metadata associated with the registered unique keyword includes an access path for the global textsite platform (108) to access the web server (136) via the Internet (126) and identifies whether the contents of the website (138), or a portion thereof, are converted dynamically (i.e., on demand) or statically (i.e., pre-converted and stored).

Generally, a publisher may be any person or entity that publishes information/content of a textsite (e.g., textsite (118a)) for users to access via a text messaging service or other network service. More specifically, a publisher may be any developer or service provider that provides a service or a product for users. For example, a publisher may be a restaurant owner that creates a textsite to provide information about his/her restaurant.

In one or more embodiments, a user is defined as a person or entity accessing content published by publishers and registered with the global textsite platform (108). As noted above, the published and registered content may be hosted by the global textsite platform (108). In one or more embodiments, a user is a person or entity with a mobile device that does not have a data plan subscription. Rather, the user is able to obtain data using the mobile device only via a TMS. That is, embodiments of the invention pertain specifically to users accessing content only via a TMS. Those skilled in the art will appreciate, however, that although embodiments of the invention target users that communicate via a TMS, the invention is not limited to such users. Specifically, while embodiments of the invention are directed to providing access to textsites to users using a mobile phone via a TMS, some users may be provided with the capability to access content on the global textsite platform (108) via a computing device (128), such as a desktop computer, a laptop computer, a thin computer, a combination thereof, or any other suitable electronic computing device that is capable of connecting to the global textsite platform (108) via the Internet (126). For example, in one or more embodiments, a user may use a text message emulator executing on the computing device (128) to connect to the global textsite platform (108) via the Internet (126). Alternatively, users with smart phones and/or mobile devices that support Internet browsing functionality could access content on the global textsite platform (108) using the Internet (126).

Further as shown in FIG. 1, a user may possess the user mobile device (102) that is communicatively coupled to the global textsite platform (108) via the telecommunication network (130) and the Internet (126). The user mobile device (102) includes a display (104), a microchip (105), a TMS input/output module (106), and a phone number (107). The user mobile device (102) may be any mobile device, such as a Code Division Multiple Access (CDMA) device, a global system mobile (GSM) device, a 3G device, a 4G device, a smart phone, a tablet, a pad device, a gaming device, a personal digital assistant, or any other suitable mobile device that includes text messaging functionality. In one or more embodiments of the invention, the user mobile device (102) is operatively connected to a global textsite platform (108) via a telecommunication network (130). The telecommunication network (130) may be any network that facilitates the exchange of messages from one part of the network to another. For example, the telecommunication network (130) may be a wide area network, a local area network, a public switched telephone network (PSTN), or any other suitable network for exchanging messages between the global textsite platform (108) and the user mobile device (102).

The display (104) of the user mobile device (102) may be a display screen using technology such as liquid crystal display (LCD), a light emitting diode (LED), organic light emitting diode (OLED), or any other suitable type of display screen capable of displaying the content of received text messages and the content of a text message that is being composed on the user mobile device (102). The microchip (105) may be any tangible hardware processor(s) or microprocessor(s) for executing the functionalities of the user mobile device (102). More specifically, the microchip (105) executes the software application(s) that provide functionalities such as browsing, text messaging, maintaining a contact list and making phone calls, etc. The TMS input/output module (106) may be a virtual keyboard, a physical keyboard, or any other input/output device(s) or button(s) that allows the publisher to compose text messages and receive and read text message responses.

In one or more embodiments of the invention, user mobile device (102) includes Phone number (107), which is the assigned phone number of the mobile device. Phone number (107) may be used by the global textsite platform (108), application, or other component such as an application programming interface (API), to identify a time zone for user mobile device (102). The time zone may be identified in any manner now known or later developed. For example, the time zone may be identified based off of an area code, country code, local code, and/or any other suitable basis. Phone number (107) may be provided to the platform when, for example, the user agrees to the terms and conditions of using the platform, or by downloading an application. In one or more embodiments of the invention, user mobile device (102) may include a Global Positioning System (GPS) component (not shown) used for location services. The GPS component may be used to determine the location of user mobile device (102), and the location may subsequently be used to calculate a time zone for user mobile device (102).

In the user system (100) of FIG. 1, the global textsite platform (108) is configured to receive a text message from the user mobile device (102) that includes a request to access a textsite hosted by the global textsite platform (108). Further, the global textsite platform (108) is configured to process the request received from the user mobile device (102), and to provide the content from the desired textsite to the user's mobile device (102) via a TMS.

To facilitate this interaction with a user mobile device (102), the global textsite platform (108) includes an agent (115). In one or more embodiments of the invention, the agent (115) may be software that is the component of the global textsite platform (108), which communicates with a user mobile device (102). Specifically, the agent (115) is configured with functionality to receive a text message (i.e., a user message) from a user mobile device (102), parse the text message for the relevant keywords or platform-specific syntax, and respond to the user request by identifying and retrieving the content from the requested textsite/converted website for delivering back to the user mobile device (102) in accordance with one or more embodiments of the invention. In one or more embodiments, the content is delivered to the user mobile device (102) in a text message sent from the global textsite platform (i.e., a GTP message).

In one or more embodiments of the invention, the agent (115) is configured to identify, based on the registry (113), a registered unique keyword (i.e., used as site identifier) in the user message as a request to access the textsite (118a) hosted on the global textsite platform (108) or the textsite (128a) hosted on the third party server (126a). Accordingly, the agent (115) is configured to access the textsite (118a) or the textsite (128a) using the aforementioned access path included in the associated metadata. In one or more embodiments, the agent (115) is configured to exchange text messages with the user mobile device (102) for navigating a text page hierarchy of the textsite (118a) or the textsite (128a). In one or more embodiments, the textsite (118a) and the textsite (128a) include textsite map (119) and textsite map (129), respectively, that describe the hierarchical relationships of text pages included within each textsite (118a, 128). For example, the textsite map (119) and the textsite map (129) may each include a data structure (e.g., graph, tree, linked list, file, database, etc.) including navigating keywords defined by the respective publisher. Generally speaking, navigating keyword information (e.g., access information such as location, address, or other information enabling access to a text page pointed to by a navigating keyword) and navigation paths among text pages in the textsite (e.g., textsite (118a)) are stored in the textsite map (e.g., textsite map (129)). Specifically, a navigation path leads from one text page to another via intervening text pages accessed using the navigating keywords included in each of the text pages traversed along the navigation path.

In one or more embodiments of the invention, the agent (115) is configured to identify, based on the registry (113), a registered unique keyword (i.e., used as site identifier) in the user message as a request to access the website (138) hosted on the web server (136). For example, such registered unique keyword may be registered by a publisher of an adaptor plug-in that maps the website map (139) into a global textsite platform syntax suitable for the adaptor (120) to convert contents of the website (138). Accordingly, the agent (115) is configured to activate the adaptor (120) for accessing the website (138) using the aforementioned access path included in the associated metadata. In one or more embodiments, the agent (115) is configured to exchange text messages with the user mobile device (102) and convert between such text messages in the global textsite platform syntax (e.g., navigating keywords) and the website map (139) for navigating a website document hierarchy of the website (138). For example, the mapping between such navigating keywords and the website map (139) may be included in an adaptor plug-in for the website (138) where the navigating keywords are defined by the publisher of the adaptor plug-in.

In one or more embodiments of the invention, the agent (115) is configured to identify a web URL (i.e., used as website identifier in Universal Resource Locator format) in the user message as a request to access the website (138) hosted on the web server (136). Accordingly, the agent (115) is configured to activate the adaptor (120) for accessing the website (138) using the identified web URL via the Internet (126). The subsequent navigation of the website (138) may be essentially the same as described above.

In one or more embodiments of the invention, messaging module (121) is a module, component, API, or other suitable component for sending messages, notifications, requests, etc. to users (i.e., user mobile device (102)) of an application or platform. Messaging module (121) may work with agent (115) or any other suitable component for sending messages. In one or more embodiments of the invention, messaging module (121) includes functionality for identifying time zones of the intended targets of a message, as well as functionality for calculating a delay—thereby ensuring that the message arrives at the intended time (e.g., when 3:00 pm occurs in each respective time zone). Specifically, messaging module (121) greatly improves the ease with which an individual may send bulk message out to, for example, all worldwide users of an application. Rather than having to address users individually and/or determine the time zone of users, the publisher may specifying one time, and messaging module (121) is able to handle all necessary conversions and delays to ensure that the message arrives at the same time in every time zone (e.g., the message is received at 10:00 am local time in each of the respective time zones). It will be apparent to one of ordinary skill in the art that, in order for the message to arrive at users in each individual time zone at 10:00 am, some users will receive the message earlier than others, depending in which time zone they are located.

In one or more embodiments of the invention, messaging module (121) identifies time zones for users (e.g., user mobile device (102)) based off of the phone number (107) of the user. For example, if a phone number is in the United States, and is 408-123-4567, based on the area code, messaging module (121) is able to determine that the number is in the Pacific Time Zone, and may calculate the delay accordingly. Likewise, if the number is 281-123-4567, messaging module (121) may identify that the number is in the Central Time Zone. Alternatively, messaging module (121) may utilize GPS in identifying time zones, thereby identifying the time zone in which the user is currently located, rather than the time zone in which the user's phone is originally from (e.g., the user of the 408-123-4567 phone number is on vacation in New York, GPS would identify that the user is in the Eastern Time Zone, while using the phone number alone would still identify the user as being in the Pacific Time Zone). It will be apparent to one of ordinary skill in the art that there are many ways to identify the time zone of a user and, as such, the invention should not be limited to the above examples.

In one or more embodiments of the invention, messaging module (121) may generate the messages for delivery concurrently with calculating a delay for the message, and may then store both the message and the delay. Thus, when the delay expires the message does not require further processing and is ready to be delivered. Alternatively, in one or more embodiments of the invention, messaging module (121) includes support for call-back URLs, enabling the content of the message to be retrieved just-in-time, and allowing updates to the message to automatically occur between the time when the publisher sends the message (or sets the message to be sent), and when the message arrives at a given location. For example, an application is sending a message to all users at 3:00 pm in their respective time zones, indicating their accomplishments for the week. If this message was set up hours, or even days, in advance, it is possible that a user may accomplish something between the time that the message was set up, and when the message is delivered to them. Thus, by utilizing a call-back URL, the most up-to-date information may be included in the message, and the user will have their most recent accomplishments included in the message sent by the application. It will be apparent to one of ordinary skill in the art that there are many ways to perform just-in-time content updating/gather and, as such, the invention should not be limited to the above example.

In one or more embodiments of the invention, the call-back URL may be implemented in any manner now known or later developed. In one or more embodiments of the invention, the call-back URL may link to a web server (e.g., web server (136), or a global textsite platform (e.g., global textsite platform (108)). The call-back URL may, for example, specify a website that is unique to the user for which the message is intended, and the content of that website may be used by messaging module (121) to generate the content of the message. In one or more embodiments of the invention, the locations used by the call-back URLs may be private websites accessible only by messaging module (121). Alternatively, the locations used by the call-back URLs may be public websites, global textsite locations, and/or any other suitable location from which content for a message may be derived.

In one or more embodiments of the invention, the textsite (118a), the textsite (128a), and/or the website (138) are configured to integrate contents from each other. In such embodiments, the textsite map (119), the textsite map (129), and/or the website map (139) are configured to include registered unique keywords (i.e., used as site identifiers) of other textsites and/or websites, which may be included in user text messages for redirecting the user mobile device (102) from one site (e.g., one of the textsite (118a), the textsite (128a), and the website (138)) to another during navigation of textsite content or converted website content.

In one or more embodiments of the invention, the aforementioned text messages exchanged between the user mobile device (102) and the global textsite platform (108), and more specifically between the user mobile device (102) and the agent (115), are of the same TMS protocol. Alternatively, text messages exchanged may include more than one TMS protocol. For example, the user messages may be SMS and the GTP messages may be MMS. Additional combinations are also possible in other examples.

Although the description above uses the user mobile device (102) in various example embodiments, those skilled in the art will appreciate that similar functionalities may be achieved by substituting the user mobile device (102) with the computing device (128). Further, the aforementioned redirecting functionality may be adapted to allow browsing of website (138) using the computing device (128) to be redirected to accessing a textsite (e.g., textsite (118a) or textsite (128a)) using the user mobile device (102) and vice-versa.

Although the GTP data (e.g., keywords, registry, textsite map, etc.) shown in FIG. 1 above are described in specific formats and organizations, those skilled in the art with the benefit of this disclosure will recognize that GTP data may be in other formats or organizations without deviating from the spirit of the invention.

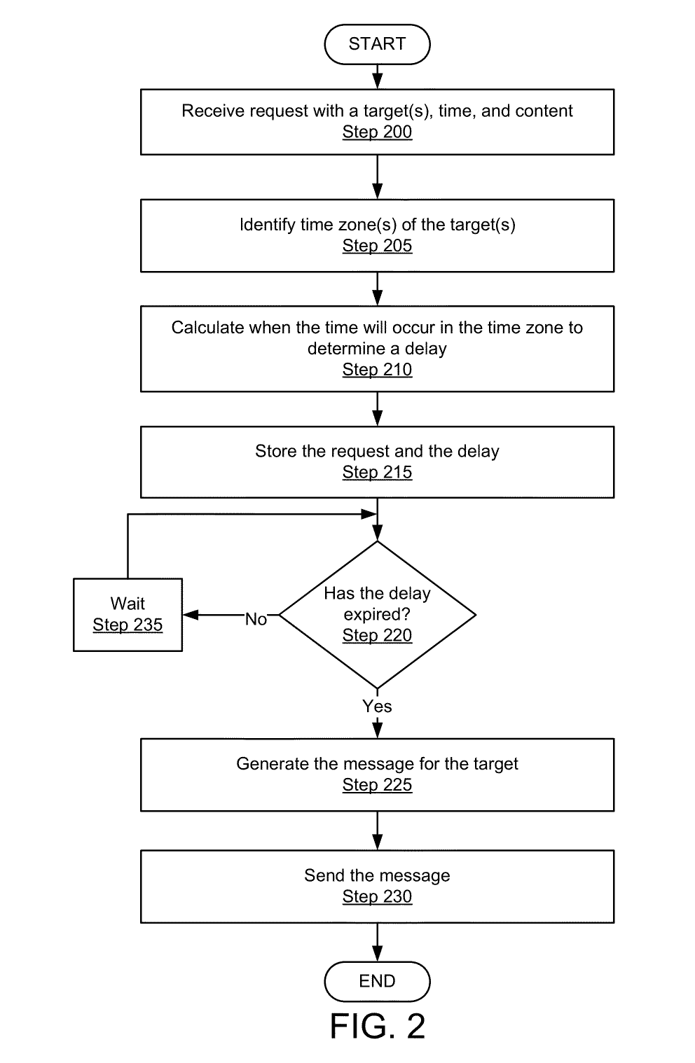

FIG. 2 shows a flowchart of a method for sending a message using a platform. While the various steps in this flowchart are presented and described sequentially, one of ordinary skill in the art will appreciate that some or all of the steps may be executed in different orders and some or all of the steps may be executed in parallel. Further, in one or more embodiments of the invention, one or more of the steps described below may be omitted, repeated, and/or performed in a, different order. Accordingly, the specific arrangement of steps shown in FIG. 2 should not be construed as limiting the scope of the invention.

In Step 200 a request is received with a target, time, and content, in accordance with one or more embodiments of the invention. The request may be received from any suitable source including, but not limited to: cell phones, smart phones, feature phones, laptop computers, desktop computers, servers, and/or any other computing device. Typically, the request is received from a publisher of an application or service, using one of the above computing devices. The request may be received in any format now known or later developed. In one or more embodiments of the invention, the request is received at a platform, via an API, or other suitable module or component. The target specified in request is the intended recipient(s) of a message, which is generated and sent in response to the request. The request may be directed towards a single individual, or a group of users. The target(s) may be identified by any suitable identifier(s). In one or more embodiments of the invention, each target is identified by a phone number. The time of the request indicates the time when a message (which is generated and sent in response to the request) should be sent or delivered. For example, a time of 10:00 am would cause a message to be sent or delivered when 10:00 am occurs in each time zone, as explained below.

In one or more embodiments of the invention, the content specifies the content of the message to be generated and sent in response to the request. The content may take any form include, but not limited to, text, image, audio, other content being sent to the target, or any combination thereof. In one or more embodiments of the invention, the content includes a call-back URL. When the content is a call-back URL, the message (which is generated and sent in response to the request) includes content that includes the most recent available information by accessing the call-back URL on or after the time (as specified in the request). It will be apparent to one of ordinary skill in the art that there are many ways to structure a request and, as such, the invention should not be limited to the above examples.

In Step 205, a time zone of the target is identified, in accordance with one or more embodiments of the invention. The time zone may be identified using any suitable method. For example, the time zone may be identified based on the phone number of the user. The country code, area code, local code, or other components of the phone number may reveal the geographical location where the phone originates from, and the time zone may be derived from that geographical location. Alternatively, the time zone may be identified using GPS or some other location service. It will be apparent to one of ordinary skill in the art that the time zone may be identified in many different ways and, as such, the invention should not be limited to the above examples.

In Step 210, a delay is determined by calculating when the time will occur in the time zone(s), in accordance with one or more embodiments of the invention. The delay may be calculated in any manner now known or later developed. In one or more embodiments of the invention, the delay is calculated using a comparison between the time the message should be sent or delivered and the current time of the time zone (i.e., the time zone in which the target of the message is currently located). Multiple delays may be calculated (e.g., one per time zone, one per user, etc.) based upon number and distribution of targets across time zones. It will be apparent to one of ordinary skill in the art that there are many ways to calculate a delay and, as such, the invention should not be limited to the above examples.

In Step 215, the request and the delay are stored, in accordance with one or more embodiments of the invention. The request and the delay may be stored at any suitable location, and in any suitable format using any method now known or later developed. The request and the delay may be stored together, or may be stored separately. In one or more embodiments of the invention, the request and delay are stored in a queue, although any suitable structure may be used. In one embodiment of the invention, there is a request and delay stored for each target of the request. Alternatively, there is a request and delay stored for each group of targets, where all targets in the group are located in the same time zone. The request and delay may be stored using a combination of the above embodiments without departing from the invention.

If the target specifies multiple recipients in different time zones, step 215 may include storing a request along with each of the calculated delays (i.e., one per time zone).

Continuing with FIG. 2, in Step 220, a determination is made about whether the delay has expired, in accordance with one or more embodiments of the invention. In one embodiment of the invention, the delay expires when (i) the local time of the time zone in which the target of the message is located is equal to the time specified in the message or (ii) the local time of the time zone in which the target of the message is located is greater than the time specified in the message. The determination may be made using any method now known or later developed. If the delay has not expired, the method proceeds to Step 230. If the delay has expired, the method proceeds to Step 225.

In Step 225, the message is generated for the target, where the message includes a payload generated based on the content specified in the request, in accordance with one or more embodiments of the invention. The message may be generated for the target in any manner now known or later developed. Alternatively, the message is generated after the delay has expired, or at any other suitable time. The payload may include the content (or a portion thereof) specified in the request. Alternatively, payload may be generated using the content when the content is a call-back URL. Specifically, the call-back URL links to a website, textsite, or other location that may be used to generate the message. Thus, the location linked to in the call-back URL may be updated while waiting for the delay to expire, and when the message is generated, it will use the most up to date information. In one or more embodiments of the invention, the message may also include other information such as, but not limited to, sender information, delivery time information, information identifying other recipients, and/or any other information. It will be apparent to one of ordinary skill in the art that there are many ways and times to generate a message and, as such, the invention should not be limited to the above examples.

In Step 230, the message is sent, in accordance with one or more embodiments of the invention. In one embodiment of the invention, the message that is sent in step 230 may or may not include when the message is actually sent or when the message is intended to be delivered. The message may be sent using any protocol or format now known or later developed. In one or more embodiments of the invention, the message is sent as a text message. It will be apparent to one of ordinary skill in the art that there are many ways to send a message and, as such the invention should not be limited to the above example. After Step 230, the method ends.

In Step 235, the method waits, in accordance with one or more embodiments of the invention. The wait may be for the amount of time left on the delay, or for any suitable amount of time. For example, the wait may be for a set amount of time such as 10 minutes, 15 minutes, 30 minutes, an hour, etc., or may be set to the exact amount remaining on the delay. After Step 235, the method returns to Step 220.

In one embodiment of the message may be generated and stored with the delay. In such embodiments, step 215 would be replaced with a step that includes generating the message and storing the delay associated with the message. Further, in such embodiments, the process would not require the message to be generated after the delay has expired. In another embodiment of the invention the message may be generated after step 215 but prior to the expiration of the delay.

The following section describes various examples of the invention. The examples are included to aid in the understanding of the invention and are not intended to limit the scope of the invention.

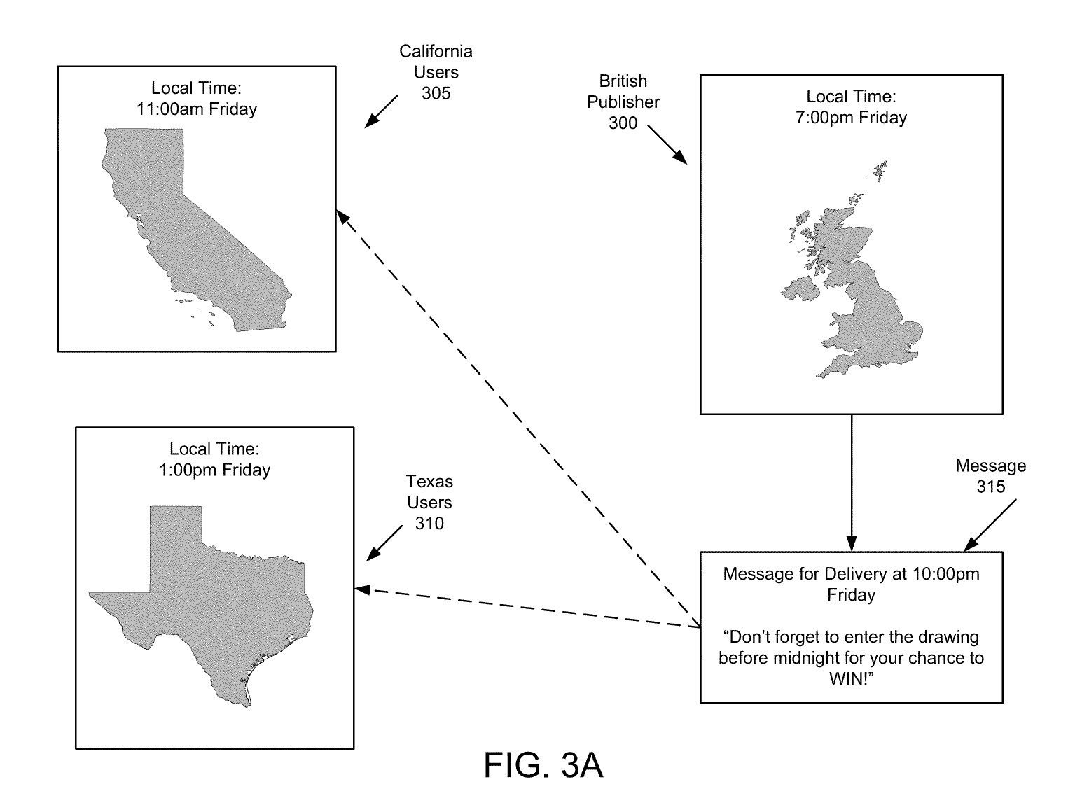

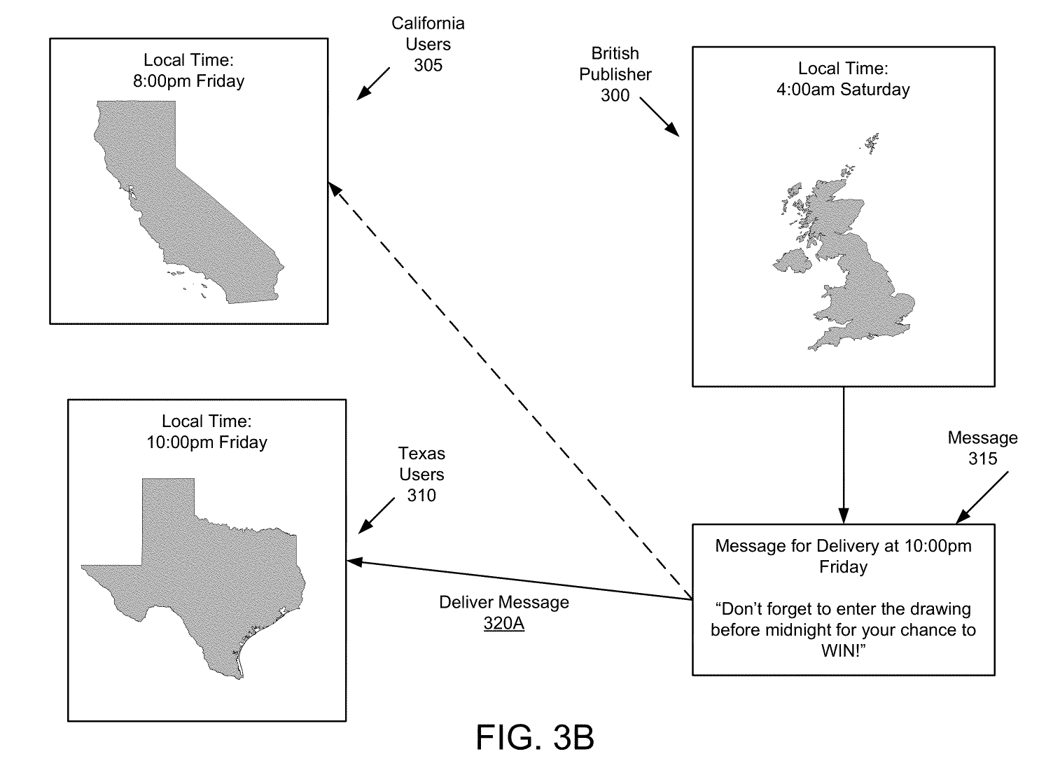

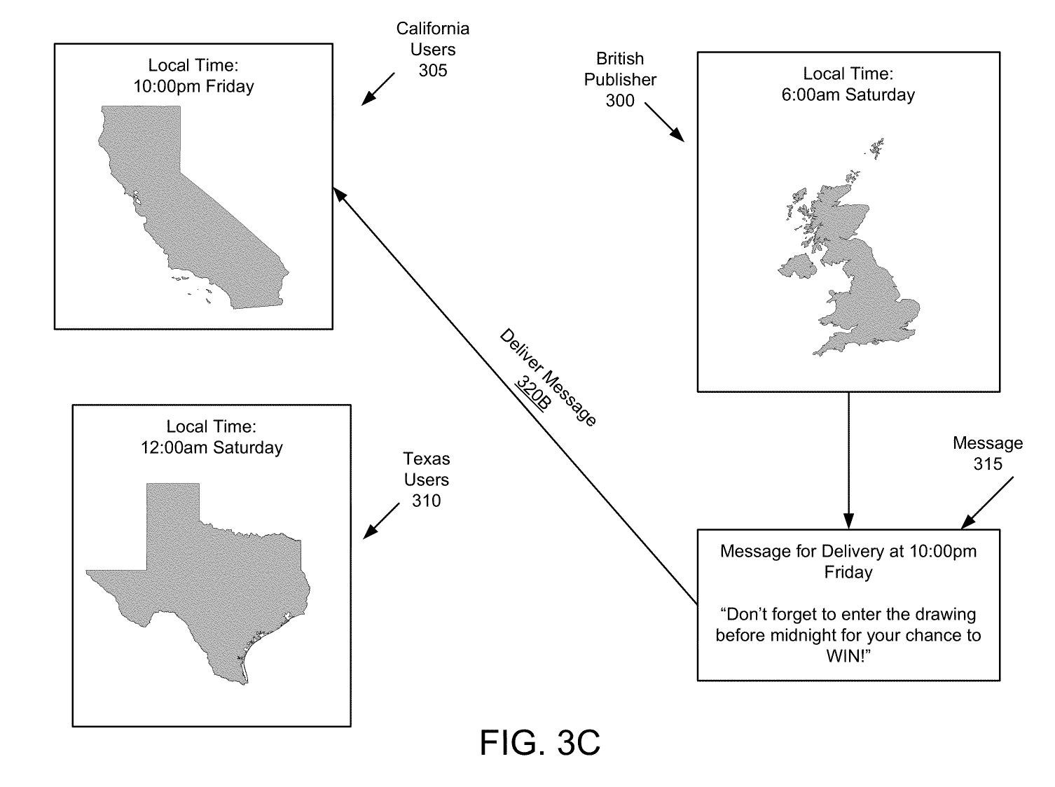

FIGS. 3A-3C show an example of sending a message using a platform. Specifically, FIG. 3A shows British publisher (300) sending message (315) to users of his application at 7:00 pm London Time. The users (also referred to as targets) are located in California (i.e., California users (305)) and Texas (i.e., Texas users (310)). By using the application developed by British publisher (300) the users agree to disclose certain information, such as their phone numbers, or other identifying information. Additionally, throughout FIGS. 3A-3C, the “local time” included within the boxes occur simultaneously. That is, 7:00 pm in London occurs at the same time as 1:00 pm in Texas and at the same time as 11:00 am in California, due to each location being in a different time zone.

In this example, British publisher (300) uses his computing device to create message (315) for delivery to users of his application. British publisher (300) identifies the target of the message as all users of his application, the time as 10:00 pm on Friday, and the content as “Don't forget to enter the drawing before midnight for your chances to WIN!” After British publisher (300) indicates that the message is complete (such as by hitting “send”) the platform identifies the time zones of all the intended recipients of the message. Because the platform already knows the phone number of the targets, the platform uses those phone numbers to determine the time zone of each target. Then, the platform calculates how long of a delay (from when the request is sent) is necessary to ensure that the message is sent or delivered at 10:00 pm Friday in each of the time zones. Thus, for this example, a nine hour delay is calculated for the Texas users (310) (10:00 pm in Texas is nine hours after 1:00 pm Texas), while an 11 hour delay (as 10:00 pm in California is 11 hours after 11:00 am in California) is calculated for the California users (305). The fact that the messages have not yet been sent in FIG. 3A is indicated by the dotted lines connecting message (315) with California users (305) and Texas users (310). Once the delay has been calculated, the message and the delay(s) are stored until the delay has expired (i.e., reached 0). Next, the example continues on in FIG. 3B.

In FIG. 3B, assume that message (315) was created by British publisher (300) at 7:00 pm London Time and that nine hours have passed since this message creation occurred in FIG. 3A. Thus, the delay associated with the message for Texas users (310) has reached 0 (i.e., the local time in Texas is at or after 10:00 pm Texas Time). Therefore, the system delivers message (320A) to Texas users (310), as indicated by the now-bold line connecting Texas users (310) and message (315). Next, the example continues on in FIG. 3C.

In FIG. 3C, two hours have passed since message (320A) was delivered to the Texas users. Thus, the delay associated with the message for California users (305) has reached 0. Therefore, the system delivers message (320B) to California users (305), as indicated by the now-bold line connecting California users (305) and message (315). Now that all messages have been delivered, the example ends.

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for sending a message using a platform, comprising:
receiving, by the platform, a request comprising at least one target, a time, and a content, wherein the time is when the message will be delivered;
identifying a time zone of the target;
calculating, by the processor, when the time will occur in the time zone of the target to determine a delay;
storing the request and the delay;
determining that the delay has expired;
generating the message for the at least one target wherein a payload in the message is based on the content; and
sending, in response to determining, the message to the target.

2. The method of claim 1, wherein the target comprises a mobile device of a user, wherein the time zone is identified based on a phone number of the mobile device, and wherein the message is sent as a text message.

3. The method of claim 2, wherein the mobile device is a feature phone.

4. The method of claim 1, wherein the target comprises a plurality of users, and wherein the at least one target is one of plurality of users.

5. The method of claim 1, wherein the content comprises a call-back uniform resource locator (URL).

6. The method of claim 5, wherein the payload is generated using updated content obtained using the call-back URL.

7. The method of claim 1, wherein the platform is a global textsite platform (GTP).

8. A non-transitory computer-readable medium (CRM) storing a plurality of instructions for sending a message using a platform, the plurality of instructions comprising functionality to:
receive, by the platform, a request comprising at least one target, a time, and a content, wherein the time is when the message will be delivered;
identify a time zone of the target;
calculate, by the processor, when the time will occur in the time zone of the target to determine a delay;
store the request and the delay;
determine that the delay has expired;
generate the message for the at least one target wherein a payload in the message is based on the content; and
send, in response to determining, the message to the target.

9. The non-transitory CRM of claim 8, wherein the target comprises a mobile device of a user, wherein the time zone is identified based on a phone number of the mobile device, and wherein the message is sent as a text message.

10. The non-transitory CRM of claim 9, wherein the mobile device is a feature phone.

11. The non-transitory CRM of claim 8, wherein the target comprises a plurality of users, and wherein the at least one target is one of plurality of users.

12. The non-transitory CRM of claim 8, wherein the content comprises a call-back uniform resource locator (URL).

13. The non-transitory CRM of claim 12, wherein the payload is generated using updated content obtained using the call-back URL.

14. The non-transitory CRM of claim 8, wherein the platform is a global textsite platform (GTP).

15. A system for sending a message using a platform, comprising:
a processor; and
a memory comprising instructions which, when executed by the processor, comprise functionality to:
receive, by the platform, a request comprising at least one target, a time, and a content, wherein the time is when the message will be delivered;
identify a time zone of the target;
calculate, by the processor, when the time will occur in the time zone of the target to determine a delay;
store the request and the delay;
determine that the delay has expired;
generate the message for the at least one target wherein a payload in the message is based on the content; and
send, in response to determining, the message to the target.

16. The system of claim 15, wherein the target comprises a mobile device of a user, wherein the time zone is identified based on a phone number of the mobile device, and wherein the message is sent as a text message.

17. The system of claim 15, wherein the target comprises a plurality of users, wherein the at least one target is one of plurality of users.

18. The system of claim 15, wherein the content comprises a call-back uniform resource locator (URL).

19. The system of claim 18, wherein the payload is generated using updated content obtained using the call-back URL.

20. The system of claim 15, wherein the platform is a global textsite platform (GTP).
